(19) United States
(12) Patent Application Publication
(10) Pub. No.: US 2025/0092838 A1
(43) Pub. Date: Mar. 20, 2025

(54) Control Method of Valve Opening and Closing

(71) Applicants: HYUNDAI MOTOR COMPANY, Seoul (KR); Kia Corporation, Seoul (KR)

(72) Inventors: Sangyeon HAN, Hwaseong-si (KR); Kiyoung KWON, Hwaseong-si (KR); Jinyoung JUNG, Hwaseong-si (KR); Young Nam KIM, Hwaseong-si (KR); You Sang SON, Hwaseong-si (KR); Back Sik KIM, Hwaseong-si (KR); Sangjae PARK, Hwaseong-si (KR)

(21) Appl. No.: 18/883,213

(22) Filed: Sep. 12, 2024

(30) Foreign Application Priority Data
Sep. 14, 2023 (KR) 10-2023-0122445

(51) Int. Cl. F02D 41/00; F01L 1/34

(52) U.S. Cl. CPC F02D 41/0007; F01L 1/34; F02D 2041/001

(57) ABSTRACT

A control method controlling valve opening and closing for an engine including an intake CVVD apparatus, an intake CVVT apparatus, an exhaust CVVD apparatus, and an exhaust CVVT apparatus is disclosed. The control method includes determining, by a controller, a driving condition region among a predetermined plurality of driving condition regions of the engine defined based on a speed and a torque of the engine, and controlling, by the controller, opening timing and closing timing of each intake valve and exhaust valve wherein the driving condition region of the engine corresponds to a predetermined low torque region, the controller outputs a control signal so that an intake valve closing (IVC) timing is before bottom dead center, and an exhaust valve opening (EVO) timing is before the bottom dead center.

### CROSS-REFERENCE TO RELATED APPLICATION

This application claims priority to and the benefit of Korean Patent Application No. 10-2023-0122445 filed in the Korean Intellectual Property Office on Sep. 14, 2023, the entire contents of which are incorporated herein by reference.

### TECHNICAL FIELD

The present disclosure relates to a control method of control method of valve opening of an engine. More particularly, the present disclosure relates to a control method of valve opening and closing of an engine that controls the duration and timing of a valve provided with a continuous variable valve duration apparatus and a continuous variable valve timing apparatus on intake and exhaust.

### BACKGROUND

The internal combustion engine generates power using explosion pressure by combusting a mixture in which fuel and air are mixed at a predetermined ratio through a predetermined ignition method.

The intake valve and exhaust valve operate by driving the camshaft by the timing belt connected to the crankshaft that converts the straight movement of the piston by explosion pressure into rotational movement. While the intake valve is open, air is sucked into the combustion chamber, and while the exhaust valve is open, the combust gas is exhausted from the combustion chamber.

Optimum engine performance can be secured only when the opening/closing timing and duration of these intake valves and exhaust valves are adjusted according to driving conditions such as engine rotation speed or load. Therefore, a Continuous Variable Valve Duration (CVVD) apparatus that controls the opening and closing time (duration) of the intake valve and exhaust valve and a Continuous Variable Valve Timing apparatus that controls the opening and closing timing of the intake valve and exhaust valve have been developed.

The CVVD apparatus controls the duration by controlling the open time of the valve. In some cases, the CVVT apparatus delays or advances the opening and closing timing of the valve while the open time of the valve is fixed. That is, when the opening timing of the valve is determined, the closing timing is automatically determined according to the duration.

### SUMMARY

The present disclosure relates to a control method of valve opening and closing for an engine equipped with a continuous variable valve duration apparatus and a continuous variable valve timing apparatus on an intake and an exhaust, respectively, simultaneously controls the duration and timing of the valve.

A control method of valve opening and closing for an engine may be applied to an engine including an intake continuous variable valve duration (CVVD) apparatus and an intake continuous variable valve timing (CVVT) apparatus provided in an intake side of the engine, and an exhaust continuous variable valve duration (CVVD) apparatus and an exhaust continuous variable valve timing (CVVT) apparatus provided in an exhaust side of the engine, and a controller.

The control method may include determining, by the controller, a driving condition region among a predetermined plurality of driving condition regions based on a speed and a torque of the engine, and controlling, by the controller, opening timing and closing timing of each intake valve and exhaust valve according to the driving condition region of the current engine by controlling of operations of the intake CVVD apparatus, the intake CVVT apparatus, the exhaust CVVD apparatus and the exhaust CVVT apparatus, wherein the driving condition region of the engine corresponds to a predetermined low torque region, the controller outputs a control signal so that an intake valve closing (IVC) timing is before bottom dead center, and an exhaust valve opening (EVO) timing is before the bottom dead center.

The opening duration of the intake valve may be within 180 crank angle (CA) degrees in the entire driving condition region.

When the driving condition region of the engine corresponds to a predetermined low speed-low torque region, the controller may output a control signal so that the intake valve closing (IVC) timing is 150 to 163 degrees from top dead center (TDC) and the exhaust valve duration is less than 165 degrees crank angle (CA).

The controller may output a control signal so that the intake valve duration is 161 degrees to 175 degrees crank angle (CA), and the exhaust valve and intake valve implement negative overlap.

When the driving condition region of the engine corresponds to a predetermined medium speed-low torque region, the controller may output a control signal so that the intake valve closing (IVC) timing is 130 degrees to 140 degrees from the top dead center (TDC) and the intake valve duration is 138 degrees to 150 degrees crank angle (CA).

The controller may output a control signal so that the exhaust valve and intake valve implement negative overlap.

When the driving condition region of the engine corresponds to a predetermined high speed-low torque region, the controller may output a control signal so that the exhaust valve duration is 170 degrees to 187 degrees crank angle (CA).

The controller may output a control signal so that the overlap of the exhaust valve and intake valve is −11 degrees to 11 degrees crank angle (CA).

When the driving condition region of the engine corresponds to a predetermined low speed-medium torque region, the controller may output a control signal so that the intake valve duration is 144 degrees to 156 degrees crank angle (CA), and the exhaust valve duration is 165 degrees to 191 degrees crank angle (CA).

The controller may output a control signal so that the overlap of the exhaust valve and intake valve is −11 degrees to 15 degrees crank angle (CA).

When the driving condition region of the engine corresponds to a predetermined medium speed-medium torque region, the controller may output a control signal so that the intake valve duration is 137 degrees to 149 degrees crank angle (CA), and the exhaust valve duration is 175 degrees to 205 degrees crank angle (CA).

The controller may output a control signal so that the overlap of the exhaust valve and intake valve is 5 degrees to 28 degrees crank angle (CA).

When the driving condition region of the engine corresponds to a predetermined high speed-medium torque region, the controller may output a control signal so that the exhaust valve opening (EVO) timing is −200 degrees to −190 degrees from the top dead center (TDC).

The controller may output a control signal so that the intake valve duration is 135 degrees to 163 degrees crank angle (CA).

When the driving condition region of the engine corresponds to a predetermined low speed-high torque region, the controller may output a control signal so that the exhaust valve opening (EVO) timing is −190 degrees to −154 degrees from the top dead center (TDC) and the exhaust valve duration is 155 degrees to 195 degrees crank angle (CA).

The controller may output a control signal so that the overlap of the exhaust valve and intake valve is 3 degrees to 20 degrees crank angle (CA).

The controller may output a control signal so that the intake valve duration is 148 degrees to 177 degrees crank angle (CA).

When the driving condition region of the engine corresponds to a predetermined medium speed-high torque region, the controller may output a control signal so that the exhaust valve opening (EVO) timing is −192 degrees to −166 degrees from the top dead center (TDC) and the exhaust valve duration expands in proportion to engine speed.

When the driving condition region of the engine corresponds to a predetermined high speed-high torque region, the controller may output a control signal so that the exhaust valve opening (EVO) timing is −205 degrees to −188 degrees from the top dead center (TDC) and the intake valve duration is 140 degrees to 173 degrees crank angle (CA).

When the driving condition region of the engine corresponds to a predetermined low torque region, the controller may output a control signal so that the exhaust valve opening (EVO) timing is less than −190 degrees from the top dead center (TDC).

In some implementations, optimal control may be achieved in various engine operation conditions by controlling the duration and the timing of valves.

By optimally controlling the opening and closing timing of the intake valve and exhaust valve, fuel efficiency can be improved by reducing pumping loss in partial torque conditions, and engine performance can be improved in high torque conditions.

In some implementations, in the case of an engine with a turbocharger mounted, sufficient low-end torque can be secured in the low speed-high torque region, allowing the turbocharger to be driven more effectively.

In addition, the effects that can be obtained or expected due to the implementations of the present disclosure will be disclosed directly or implicitly in the detailed description of the implementations of the present disclosure.

That is, various effects expected according to implementations of the present disclosure will be disclosed in the detailed description to be described later.

### BRIEF DESCRIPTION OF THE DRAWINGS

Since these drawings are intended for reference in explaining an exemplar disclosure of the present disclosure, the technical idea of the present disclosure should not be interpreted as limited to the accompanying drawings.

FIG. 1 is a block diagram showing an example of an engine to implement a control method of valve opening and closing.

FIG. 2 is a perspective view showing an example of a continuous variable valve duration apparatus and a continuous variable valve timing apparatus of the engine.

FIG. 3 is a drawing showing an example of a driving condition region used for the control method of valve opening and closing control method.

FIG. 4 is a flowchart showing the control method of valve opening and closing for the engine.

FIG. 5 to FIG. 7 is an example of a control table for each driving condition region of the engine used for the control method of valve opening and closing for the engine.

### DETAILED DESCRIPTION

In the following detailed description, only certain exemplar disclosures of the present disclosure have been shown and described, simply by way of illustration. As those skilled in the art would realize, the described implementations may be modified in various different ways, all without departing from the spirit or scope of the present disclosure.

As used herein, the terms “car,” “vehicle,” “vehicular,” “automobile,” or other similar terms as used herein are inclusive of motor vehicles in general. Such motor vehicles may encompass passenger automobiles including sports utility vehicles (SUVs), buses, trucks, various commercial vehicles, passenger cars, and hybrid vehicles. Such motor vehicles may also include plug-in hybrid electric vehicles, hydrogen-fueled vehicles, and other alternative fuel vehicles (e.g., fuels derived from sources other than petroleum). As referred to herein, a hybrid vehicle is a vehicle that has two or more sources of power, for example vehicles that are powered by both gasoline and electricity.

Additionally, some methods may be executed by at least one controller. The term controller refers to a hardware apparatus that contains memory and a processor designed to execute at least one step that translates into an algorithm structure. The memory is intended to store algorithm steps, and the processor is specifically designed to execute the algorithm steps in order to perform at least one of the processes described below.

Furthermore, the control logic of the present disclosure may be implemented in a non-transitory computer-readable medium on a computer-readable medium containing executable program instructions executed by a processor, controller, or the like. Examples of computer readable media include, but are not limited to, read-only memory (ROM), random-access memory (RAM), compact disk (CD)-ROM, magnetic tape, floppy disk, flash drive, smart card and optical data storage apparatus. Reproduction media readable by a computer may be distributed to computer systems connected to a network and stored and executed in a distributed manner by, for example, a telematics server or Controller Area Network (CAN).

An exemplar disclosure will hereinafter be described in detail with reference to the accompanying drawings.

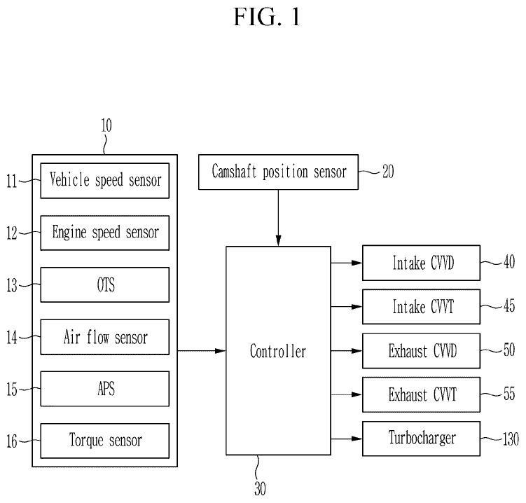

FIG. 1 is a block diagram showing an example of an engine that performs a control method of valve opening and closing for the engine.

As shown in FIG. 1, in some implementations, an engine includes a data detector 10, a camshaft position sensor 20, a controller 30, an intake continuous variable valve duration (CVVD) apparatus 40, an intake continuous variable valve timing (CVVT) apparatus 45, an exhaust continuous variable valve duration (CVVD) apparatus 50, and an exhaust continuous variable valve timing (CVVT) apparatus 55.

The data detector 10 detects data related to the current operation state of the vehicle in order to control the continuous variable valve duration apparatus and continuous variable valve timing apparatus provided in the intake and exhaust, and may include a vehicle speed sensor 11, an engine speed sensor 12, an oil temperature sensor 13, an air flow sensor 14, an accelerator pedal position sensor (APS) 15, and a torque sensor 16.

The vehicle speed sensor 11 detects the speed of the vehicle and transmits the corresponding signal to the controller 30, and may measure the rotational speed of the vehicle's wheels.

The engine speed sensor 12 detects the engine speed according to the phase change of the crankshaft or the phase change of the camshaft and transmits the corresponding signal to the controller 30.

The oil temperature sensor (OTS) 13 may detect the oil temperature, for example, the temperature of oil flowing through an oil control valve (OCV) and transmit the corresponding signal to the controller 30.

The oil temperature detected by the oil temperature sensor 13 may also be predicted by measuring the coolant that cools the engine using a coolant temperature sensor mounted on the coolant passage of the intake manifold. Therefore, in the present specification and claims, it should be understood that the oil temperature sensor 13 includes a coolant temperature sensor, and the oil temperature includes the coolant temperature.

The air flow sensor 14 detects the amount of air flowing into the intake manifold and transmits the corresponding signal to the controller 30.

The accelerator pedal position sensor (APS) 15 detects the degree to which the driver presses the accelerator pedal. When the accelerator pedal is fully pressed, the position value of the accelerator pedal may be 100%, and when the accelerator pedal is not pressed, the position value of the accelerator pedal may be 0%.

Instead of the accelerator pedal position sensor 15, a throttle valve opening sensor (TPS) mounted on the intake passage may be used. Therefore, in the present specification and claims, it should be understood that the accelerator pedal position sensor 15 includes a throttle valve opening sensor, and the position value of the accelerator pedal includes the opening degree of the throttle valve.

The torque sensor 16 measures the torque of the engine, that is, the torque of the crankshaft, etc., and transmits the corresponding signal to the controller 30.

The camshaft position sensor 20 detects changes in the angle of the camshaft and transmits the corresponding signal to the controller 30.

The engine to which the control method may be applied may further include turbocharger 130. The controller 30 may control the operation of the turbocharger 130 according to the output signal of the data detector 10 and the camshaft position sensor 20. For example, the turbocharger 130 may include a wastegate, and the controller 30 may open and close the wastegate according to the output signals of the data detector 10 and the camshaft position sensor 20. The configuration and operation of the turbocharger 130 are obvious to those skilled in the art, so detailed descriptions are omitted.

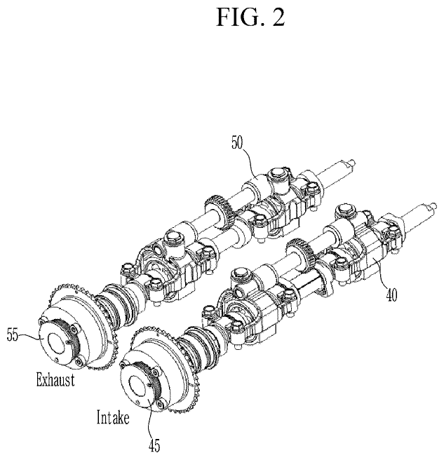

FIG. 2 is a perspective view of a continuous variable valve duration apparatus and a continuous variable valve timing apparatus that may be applied to an engine.

As shown in FIG. 2, in an exemplary disclosure, the intake continuous variable valve duration apparatus 40 and the intake continuous variable valve timing apparatus 45 are mounted on the intake, and the exhaust continuous variable valve duration apparatus 50 and the exhaust continuous variable valve timing apparatus 55 are mounted on the exhaust.

The intake continuous variable valve duration (CVVD) apparatus 40 controls the intake valve open duration of the engine according to a signal from the controller 30.

The intake continuous variable valve timing (CVVT) apparatus 45 controls the opening and closing timing (shifting phase) of the intake valve of the engine according to the signal of the controller 30.

The exhaust continuous variable valve duration (CVVD) apparatus 50 controls exhaust valve open duration of the engine according to the signal from the controller 30.

The exhaust continuously variable valve timing (CVVT) apparatus 55 controls the opening and closing timing (shifting phase) of the exhaust valve of the engine according to the signal from the controller 30.

The controller 30 determines which driving condition region of a predetermined a plurality of driving condition regions corresponds to the driving condition region of the engine according to the engine speed and torque signal of the data detector 10, and the controller 30 controls the operation of the intake CVVD apparatus 40, the intake CVVT apparatus 45, the exhaust CVVD apparatus 50 and the exhaust CVVT apparatus 55 according to a corresponding driving condition region.

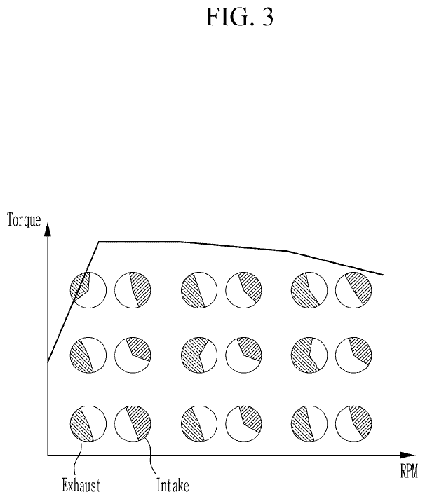

FIG. 3 is a drawing showing a driving condition region to which the control method of valve opening and closing control method of an engine according to an implementation of the present disclosure may be applied.

The plurality of driving condition region may include a low speed-low torque region, a medium speed-low torque region, a high speed-low torque region, a low speed-medium torque region, a medium speed-medium torque region, a high speed-medium torque region, a low speed-high torque region, a medium speed-high torque region and high speed-high torque region. For ease of understanding, nine driving condition regions are shown in the drawing, but it is not limited to this, and various types of driving condition regions may be set in advance by considering engine size, engine type, driving area, etc.

The low torque may be defined as the low torque state of the engine, the medium torque may be defined as the medium torque state of the engine, and the high torque may be defined as the high torque state of the engine.

The low speed may be defined as low speed state of the engine, the medium speed may be defined as medium speed state of the engine, and the high speed may be defined as high speed state of the engine.

The low speed, medium speed, and high speed of the engine and the low torque, medium torque, and high torque of the engine are relative definitions and may appear in various forms depending on the specifications of the engine.

The controller 30 controls the opening and closing timing and duration of each intake valve and exhaust valve according to the current driving condition region of the engine.

The intake valve closing (IVC) timing may be before the bottom dead center (BDC) in the entire driving condition region.

In the detailed description and claim of the present disclosure, the valve opening and closing criterion refers to a predetermined position that allows a certain gap between the valve seat surface on the bottom of the cylinder head and the valve. In other words, the valve opening and closing criterion may not mean the contact moment between the valve and the valve seat, but the valve position at the moment when actual intake and exhaust are allowed. For example, a certain gap may be 1 mm, but is not limited to this.

In the valve opening and closing control method of an engine, the intake valve closing (IVC) timing is always before the bottom dead center (BDC), and the Miller cycle may be implemented. That is, the engine to which the valve opening and closing control method of the engine is applied may implement the Miller cycle by using the continuous variable valve duration apparatus and the continuously variable valve timing apparatus without any engine modification. The Miller cycle can provide relatively improved heat efficiency by providing a higher expansion ratio than a compression ratio.

In the control method of valve opening and closing of the engine, the auto cycle may be implemented.

In other words, in the control method of valve opening and closing of the engine, the intake valve closing (IVC) timing is controlled according to the driving condition region of the engine to implement the Miller cycle and Otto cycle to achieve enhancement of fuel efficiency and desired performance.

The opening duration of the intake valve may be within 180 crank angle (CA) degrees throughout the driving condition region. In the control method of valve opening and closing of the engine, the opening duration of the intake valve is limited to within 180 crank angle (CA) degrees, making it possible to implement the Miller cycle that provides a relatively low compression ratio. In addition, an auto cycle may be implemented depending on the engine operation status, enabling enhancement of fuel efficiency and maintenance of desired performance.

The controller 30 may be implemented as one or more processors operated by a set program, and the set program may be programmed to perform each step of the valve timing control method of the continuous variable valve duration engine.

Various exemplary examples described herein may be implemented via a recording medium readable by a computer or a similar apparatus using, for example, software, hardware, or a combination thereof.

According to the hardware implementation, the exemplary implementation described herein may be implemented using at least one of ASICs (application specific integrated circuits), DSPs (digital signal processors), DSPDs (digital signal processing devices), PLDs (programmable logic devices), FPGAS (field programmable gate arrays, processors, controllers, micro-controllers, microprocessors, and electrical units for performing other functions.

According to software implementation, exemplary implementations such as procedures and functions described in this specification may be implemented as separate software modules. Each of the software modules may perform at least one function and operation described in this specification. Software code may be implemented as a software application written in an appropriate programming language.

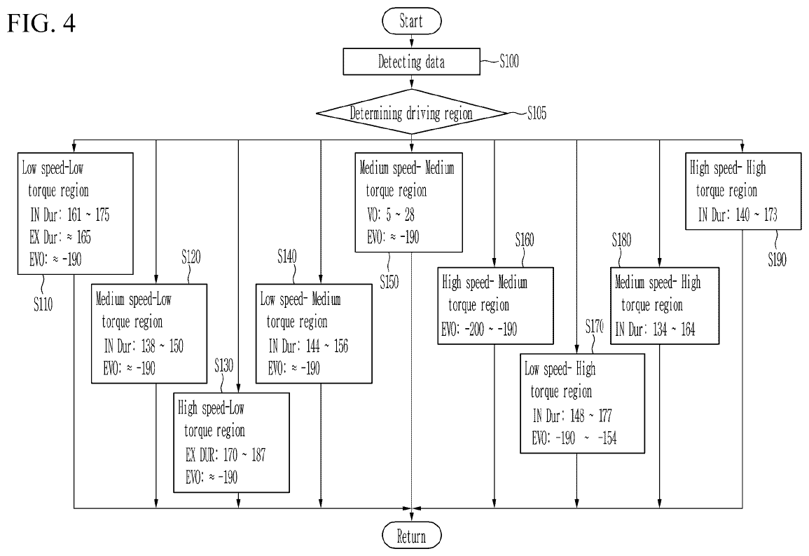

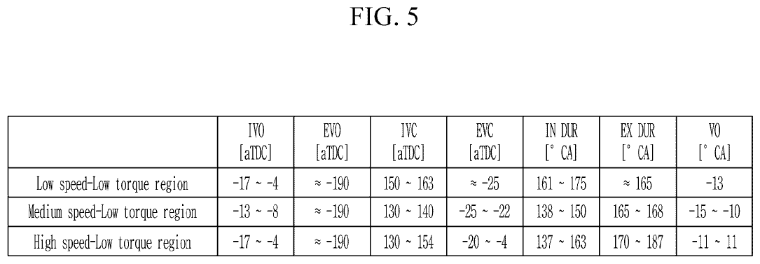

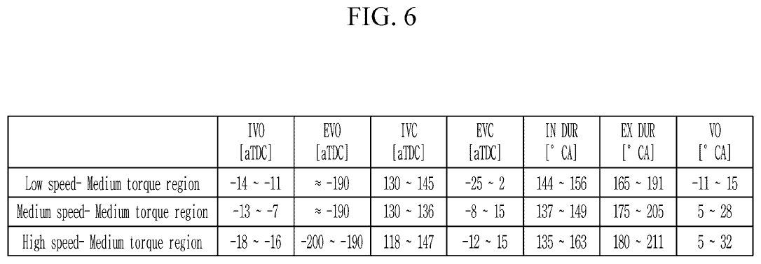

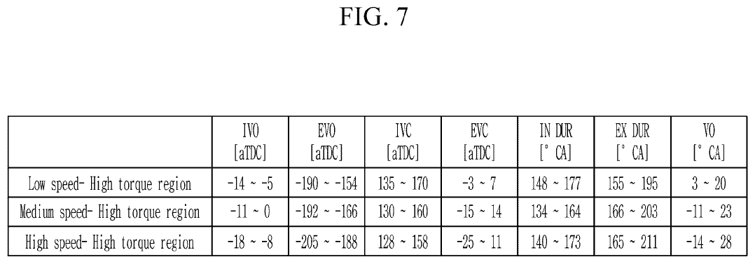

FIG. 4 is a flowchart showing the control method of valve opening and closing of an engine, and FIG. 5 to FIG. 7 is a control table for each driving condition region of the engine to which the control method of valve opening and closing of an engine is applied.

In FIG. 5 to FIG. 7, EVO (Exhaust Valve Opening) and EVC (Exhaust Valve Closing) refer to the opening and closing times of the exhaust valve. With top dead center (TDC) as a reference, a negative value refers to a timing before top dead center (TDC), and a positive value refers to a timing after top dead center (TDC).

In addition, IVO (Intake Valve Opening) and IVC (Intake Valve Closing) refer to the opening and closing times of the intake valve. With top dead center (TDC) as a reference, a negative value refers to a timing before top dead center (TDC), and positive value means after top dead center (TDC).

IN DUR (Intake Valve Duration) represents the duration of the intake valve, and EX DUR (Exhaust Valve Duration) represents the duration of the exhaust valve in crank angle (CA).

VO (Valve Overlap) is the amount of overlap between the intake valve and exhaust valve expressed in crank angle (CA).

Referring to FIG. 4, the control method of valve opening and closing of the engine includes step S100 in which the data detector 10 detects data related to the current driving state of the vehicle and outputs a corresponding signal.

The controller 30 determines which driving condition region the operating state of the engine corresponds to among a predetermined plurality of driving condition regions according to the output signal of the data detector 10 at S105.

For example, the controller 30 determines which driving condition region the current operation state of the engine corresponds to among the predetermined plurality of driving condition regions according to the detected engine speed and torque signal at S105.

The controller 30 divides the driving condition region into a plurality of driving condition regions according to engine speed and torque based on signals from the data detector 10 and the camshaft position sensor 20, and controls the operation of the intake CVVD apparatus 40, the exhaust CVVD apparatus 50, the intake CVVT apparatus 45, and the exhaust CVVT apparatus 55 according to the driving condition region. Here, the plurality of control regions may be divided into nine regions.

The low speed, medium speed, and high speed of the engine speed may be set to various ranges depending on the specifications of the engine, the region of use, etc., and setting the low speed, the medium speed, and the setting the high speed of the engine speed is obvious to those skilled in the art, so detailed description thereof will be omitted.

The low torque, the medium torque, and the high torque of the engine torque may be set to various ranges depending on the specifications of the engine, the usage area, etc., and setting the low torque, the medium torque, and the high torque of the engine torque is obvious to those skilled in the art, so detailed description thereof will be omitted.

The controller 30 determines which driving condition region the operation state of the engine corresponds to among the predetermined plurality of driving condition regions according to the engine speed and torque signal of data detector 10 at S105, the controller 30 controls the operation of the intake CVVD apparatus 40, the intake CVVT apparatus 45, the exhaust CVVD apparatus 50, and the exhaust CVVT apparatus 55 according to the driving condition region at S110 to S190.

In other words, the controller 30 controls the opening and closing timing of each intake valve and exhaust valve according to the driving condition region of the current engine state.

As previously explained, the intake valve closing (IVC) timing may be before bottom dead center (BDC) in the entire driving condition region. In other words, the intake valve closing (IVC) timing is always before the bottom dead center (BDC), and by implementing the Miller cycle, improved thermal efficiency may be provided through an expansion ratio that is relatively higher than the compression ratio. In addition, the Otto cycle may be implemented depending on the engine operation status, enabling enhancement of fuel efficiency and maintenance of desired performance.

The opening duration of the intake valve may be within 180 crank angle (CA) degrees in the entire driving condition region, which provides a relatively low compression ratio and enables the implementation of the Miller cycle. In addition, the Otto cycle may be implemented depending on the engine operation status, enabling enhancement of fuel efficiency and maintenance of desired performance.

In explaining the control method of the valve opening and closing of the engine, the Miller cycle and Otto cycle are relative concepts. The Miller cycle may be defined as improving fuel efficiency by implementing a relatively low effective compression ratio, and the Otto cycle may be defined as improving engine performance by implementing a relatively high effective compression ratio.

In the S105 step, if the driving condition region according to the current engine state is a low speed-low torque region, the controller 30 outputs a control signal so that the intake valve closing (IVC) timing is 150 to 163 degrees from top dead center (TDC) and the exhaust valve duration is less than 165 degrees crank angle (CA) at S110.

In the low speed-low torque region, the intake valve opening (IVO) timing may be −17 to −4 degrees from the top dead center (TDC), and the intake valve duration may be 161 degrees to 175 degrees crank angle (CA). Additionally, the exhaust valve opening (EVO) timing may be −190 degrees or less from the top dead center (TDC), and the exhaust valve closing (EVC) timing may be −25 degrees or less from the top dead center (TDC). Additionally, valve overlap (OV) may be approximately −13 degrees.

In the low speed-low torque region, the Otto cycle may be applied to the intake to increase the effective compression ratio and improve engine performance. Otto cycle is applied to the intake to ensure combust stability. In addition, the exhaust valve is applied with a short duration, so the intake valve and the exhaust valve realize negative overlap, and through this, the amount of internal EGR is limited and combust stability may be secured.

In explaining the control method of valve opening and closing of the engine, the short duration and long duration of the valve are relative concepts, and the valve duration may be defined as relatively short or long throughout the combust process.

In the S105 step, if the driving condition region according to the current engine operation state is a medium speed-low torque region, the controller 30 outputs a control signal so that the intake valve closing (IVC) timing is 130 degrees to 140 degrees from the top dead center (TDC) and the intake valve duration is 138 degrees to 150 degrees crank angle (CA) at S120.

In the medium speed-low torque region, the intake valve opening (IVO) timing may be −13 to −8 degrees from the top dead center (TDC), and the exhaust valve opening (EVO) timing may be −190 degrees or less from top dead center (TDC). And the exhaust valve closing (EVC) timing may be −25 degrees to −22 degrees from the top dead center (TDC), and the exhaust valve duration may be 165 degrees to 168 degrees crank angle (CA). Additionally, valve overlap (OV) is −15 degrees to −10 degrees, so negative overlap may be implemented.

In the medium speed-low torque region, the RPM of the engine increases compared to the low speed-low torque region, thereby enhancing the flow inside the cylinder and ensuring combust safety. Therefore, the engine efficiency may be increased by additionally opening the throttle valve and applying the Miller cycle to reduce pumping loss generated by the throttle. In addition, the intake valve and exhaust valve implement negative overlap, which limits the amount of internal EGR and ensures combust stability.

In step S105, if the driving condition region according to the current engine state is a high speed-low torque region, the controller 30 outputs a control signal so that the exhaust valve duration is 170 degrees to 187 degrees crank angle (CA) at S130. Also, the controller 30 outputs a control signal so that the overlap of the exhaust valve and intake valve is −11 degrees to 11 degrees crank angle (CA).

In the high speed-low torque region, the intake valve opening (IVO) timing may be −17 to −4 degrees from the top dead center (TDC), the intake valve closing (IVC) timing may be 130 degrees to 154 degrees from the top dead center (TDC), and the intake valve duration may be 137 degrees to 163 degrees crank angle (CA). Additionally, the exhaust valve opening (EVO) timing may be −190 degrees or less from the top dead center (TDC), and the exhaust valve closing (EVC) timing may be −25 degrees to −4 degrees from the top dead center (TDC).

In the high speed-low torque region, valve overlap may be applied by setting the exhaust closing timing to the maximum value within which combust safety is maintained. In other words, fuel efficiency may be improved by additionally reducing pumping loss by injecting internal EGR into the combustion chamber. Additionally, in order to secure the dynamic characteristic margin in the high speed region, the intake duration is slightly increased compared to the medium speed-low torque.

A typical fixed cam has a long intake duration in consideration of dynamic characteristics in the high speed region, which limits the use of the Miller cycle. However, of the control method of valve opening and closing of the engine, the CVVD apparatus is used even in the high speed-low torque region. Thus, the Miller cycle may be implemented by actively utilizing.

As described above, in the low torque region, the controller 30 controls the predetermined intake valve closing (IVC) timing to be implemented before bottom dead center (BDC), and the predetermined exhaust valve opening (EVO) timing to be implemented before bottom dead center (BDC) (S110. S120, S130).

Additionally, the controller 30 controls the exhaust valve opening (EVO) timing to be implemented at −190 degrees or less from the top dead center (TDC) (S110, S120, S130).

In the S105 step, if the driving condition region according to the current engine state is a low speed-medium torque region, the controller 30 outputs a control signal so that the intake valve duration is 144 degrees to 156 degrees crank angle (CA), and the exhaust valve duration is 165 degrees to 191 degrees crank angle (CA) at S140. In addition, the controller 30 controls the overlap (VO) of the exhaust valve and intake valve to be implemented at −11 degrees to 15 degrees crank angle.

In the low speed-medium torque region, the intake valve opening (IVO) timing may be −14 degrees to −11 degrees from the top dead center (TDC), and the intake valve closing (IVC) timing may be 130 degrees to 145 degrees from the top dead center (TDC). Additionally, the exhaust valve opening (EVO) timing may be −190 degrees or less from the top dead center (TDC), and the exhaust valve closing (EVC) timing may be −25 degrees to 2 degrees from the top dead center (TDC).

In the low speed-medium torque region, the intake valve closing (IVC) timing is 130 to 145 degrees from top dead center (TDC), allowing the use of the Miller cycle based on ensuring combust safety. In addition, the exhaust valve duration is relatively increased to 165 degrees to 191 degrees crank angle (CA) and the overlap (VO) of the exhaust valve and intake valve may be −11 degrees to 15 degrees crank angle (CA). Therefore, pumping loss may be actively reduced by utilizing the Miller cycle and valve overlap (VO), thereby improving fuel efficiency.

In the S105 step, if the driving condition region according to the current engine state is a medium speed-medium torque region, the controller 30 outputs a control signal so that the intake valve duration is 137 degrees to 149 degrees crank angle (CA), and the exhaust valve duration is 175 degrees to 205 degrees crank angle (CA) at S150. In addition, the controller 30 outputs a control signal so that the overlap of the exhaust valve and intake valve is 5 degrees to 28 degrees crank angle (CA) at S150.

In the medium speed-medium torque region, the intake valve opening (IVO) timing may be −13 degrees to −7 degrees from the top dead center (TDC), and the intake valve closing (IVC) timing may be 130 degrees to 136 degrees from the top dead center (TDC). Additionally, the exhaust valve opening (EVO) timing may be −190 degrees or less from the top dead center (TDC), and the exhaust valve closing (EVC) timing may be −15 degrees to 15 degrees from the top dead center (TDC).

In the medium speed-medium torque region, a strategy is implemented to secure fuel efficiency by maximizing valve overlap (VO).

In tests in the medium speed-medium torque region, as a result of applying the extreme Miller cycle (IVC≈110 aTDC), the valve timing deviation between driving condition regions increased and vehicle responsiveness became poor. In response to this, in order to secure a pleasant feeling of acceleration, the IVC is retarded, the intake duration is adjusted, and the valve overlap is reduced.

In the S105 step, if the driving condition region according to the current engine state is a high speed-medium torque region, the controller 30 controls the exhaust valve opening (EVO) timing to be implemented at −200 degrees to −190 degrees from top dead center (TDC) at S160. Additionally, the controller 30 controls the intake valve duration to be implemented at 135 degrees to 163 degrees crank angle (CA) at S160.

In the high speed-medium torque region, the intake valve opening (IVO) timing may be −18 degrees to −16 degrees from the top dead center (TDC), and the intake valve closing (IVC) timing may be 118 degrees to 147 degrees from the top dead center (TDC). Additionally, the exhaust valve closing (EVC) timing may be −12 degrees to 15 degrees from the top dead center (TDC), and the exhaust valve duration may be 180 degrees to 211 degrees crank angle (CA). The overlap (VO) of the exhaust valve and intake valve may be 5 degrees to 32 degrees crank angle (CA).

In the high speed-medium torque region, the exhaust valve opening (EVO) timing is slightly advanced compared to the medium speed-medium torque region, and the exhaust duration is relatively increased, reducing back pressure in the high speed region.

In the medium torque region, the manifold pressure approaches the atmospheric pressure, so the pumping loss reduction effect due to the Miller cycle is reduced. Therefore, when transitioning from the medium speed-medium torque region to the high speed-medium torque region, the intake duration is relatively increased, and the intake valve duration is set considering the pumping loss reduction effect of the Miller cycle and the thermodynamic efficiency of the Otto cycle.

In step S105, if the driving condition region according to the current engine state is a low speed-high torque region, the controller 30 controls the exhaust valve opening (EVO) timing to be implemented at −190 degrees to −154 degrees from the top dead center (TDC), and the exhaust valve duration to be implemented at 155 degrees to 195 degrees crank angle (CA) at S170. And the controller 30 outputs a control signal so that the overlap of the exhaust valve and intake valve is 3 degrees to 20 degrees crank angle (CA) at S170. Further, the controller 30 outputs a control signal so that the intake valve duration is 148 degrees to 177 degrees crank angle (CA).

In the low speed-high torque region, the intake valve opening (IVO) timing may be −14 degrees to −5 degrees from the top dead center (TDC), and the intake valve closing (IVC) timing may be 135 degrees to 170 degrees from the top dead center (TDC). Additionally, the exhaust valve closing (EVC) timing may be −3 degrees to 7 degrees from the top dead center (TDC).

In the low speed-high torque region, valve overlap (VO) may be acceptable depending on scavenging within the oxygen slip limit. In addition, it can be necessary to secure a sufficient amount of air for maximum torque, so the Otto cycle is applied.

In the case of an engine equipped with a turbocharger, it can be necessary to secure sufficient low end torque (LET) in the low speed-high torque region, and it is can be to drive the turbocharger more effectively.

In the control method, in the low speed-high torque region, the exhaust valve opening (EVO) timing is retarded after the bottom dead center (BDC), so that back pressure may increase, turbo expansion ratio may increase, turbo speed may increase, and torque may increase.

In addition, the engine to which the control method may be applied is equipped with the exhaust CVVD apparatus 50, and may actively control the exhaust flow rate as needed in the entire driving condition region. Therefore, the expensive VGT (Variable Geometry Turbocharger) may be replaced with a relatively inexpensive WGT (Wastegate Geometry Turbocharger).

In the S105 step, if the driving condition region according to the current engine state is a medium speed-high torque region, the controller 30 outputs a control signal so that the exhaust valve opening (EVO) timing is −192 degrees to −166 degrees from the top dead center (TDC) and the exhaust valve duration expands in proportion to engine speed at S180.

In the medium speed-high torque region, the intake valve opening (IVO) timing may be −11 degrees to 0 degrees from the top dead center (TDC), the intake valve closing (IVC) timing may be 130 degrees to 160 degrees from the top dead center (TDC), and the intake valve duration may be 134 degrees to 164 degrees crank angle (CA). The exhaust valve closing (EVC) timing may be −15 degrees to 14 degrees from the top dead center (TDC), and the exhaust valve duration may be 166 degrees to 203 degrees crank angle (CA). Additionally, valve overlap (OV) may be set to −11 degrees to 23 degrees.

In the medium speed high torque region, the turbo speed margin remains, so the waste gate may be completely closed, the Miller cycle may be actively utilized to reduce exhaust temperature, and the knocking characteristic may be improved. Through this, fuel efficiency may be improved by advancing the ignition timing and improving heat efficiency.

In the medium speed-high torque region, when there is 02 slip margin, the intake valve opening (IVO) timing is advanced and the exhaust valve closing (EVC) timing is retarded, forming valve overlap. Fuel efficiency may be improved by utilizing internal EGR through the valve overlap. As torque increases, the intake valve opening (IVO) timing is retarded and the exhaust valve closing (EVC) timing is advanced, reducing valve overlap to minimize O2 slip.

After sufficient low end torque (LET) is secured in the low speed-high torque region, knocking characteristics can be improved by expanding the exhaust duration in proportion to the RPM and reducing back pressure in the medium speed-high torque region.

In the S105 step, if the driving condition region according to the current engine state is a high speed-high torque region, the controller 30 outputs a control signal so that the exhaust valve opening (EVO) timing is −205 degrees to −188 degrees from the top dead center (TDC) and the intake valve duration is 140 degrees to 173 degrees crank angle (CA) at S190.

In the high speed-high torque region, the intake valve opening (IVO) timing may be −18 degrees to −8 degrees from top dead center (TDC), and the intake valve closing (IVC) timing may be 128 degrees to 158 degrees from the top dead center (TDC). The exhaust valve closing (EVC) timing may be −25 degrees to 11 degrees from the top dead center (TDC), and the exhaust valve duration may be set to 165 degrees to 211 degrees crank angle (CA). Additionally, valve overlap (VO) may be set to −14 degrees to 28 degrees crank angle (CA).

If the Miller cycle is actively used in the high speed-high torque region, it will place excessive strain on the turbo, so limiting the turbo speed is necessary. Increasing the intake duration secures additional air volume and reduces turbo boosting load. Therefore, margin of turbo speed may be secured. Knocking characteristic and back pressure characteristic may be enhanced by increasing the exhaust duration in proportion to engine speed (RPM) after low end torque (LET), that is, by advancing the exhaust valve opening (EVO) timing.

In some implementations, optimal control may be achieved in various engine operation conditions by continuously and simultaneously controlling the valve duration and valve timing.

According to an exemplary disclosure of the control method of valve opening and closing of the engine, engine efficiency may be improved and combust stability may be secured by utilizing the Otto cycle in the low speed-low torque region.

According to an exemplary disclosure of the control method of valve opening and closing of the engine, throttle pumping loss may be reduced and engine efficiency may be increased by applying the Miller cycle in the medium speed-low torque region.

According to the control method of the valve opening and closing of the engine, in the high speed-low torque region, overlap is used by setting the exhaust closing timing to the maximum value within the limit where combust safety is maintained, and through this, enhancement of fuel efficiency is possible by additionally reducing pumping loss by applying internal EGR.

According to the control method of valve opening and closing of the engine, in the low speed-medium torque region, pumping loss is actively reduced by utilizing the Miller cycle and valve overlap, which enables enhancement of fuel efficiency.

According to an exemplary disclosure of control method of valve opening and closing of the engine, fuel efficiency may be secured by maximizing valve overlap in the medium speed-medium torque region.

According to an exemplary disclosure of the control method of valve opening and closing of the engine, the exhaust duration may be increased by slightly advancing the EVO timing in the high speed-medium torque region, and thus back pressure may be reduced in the high speed region.

According to the control method of valve opening and closing of the engine, in the low speed-high torque region, by delaying EVO after BDC, the back pressure is increased to increase the expansion ratio of the turbocharger, thereby increasing the turbocharger speed and increasing torque.

According to the control method of the valve opening and closing of the engine, in the medium speed high torque region, after fully closing the west gate, the Miller cycle may be actively utilized to reduce exhaust temperature, and by improving the knocking characteristic, the ignition timing may be advanced and heat efficiency may be improved.

According to the control method of valve opening and closing of the engine, in the high speed-high torque region, it is possible to secure the amount of air by increasing the intake duration and secure the speed margin of the turbocharger by reducing the turbo boosting load.

While this disclosure has been described in connection with what is presently considered to be practical exemplar disclosures, it is to be understood that the disclosure is not limited to the disclosed implementations. On the contrary, it is intended to cover various modifications and equivalent arrangements included within the spirit and scope of the appended claims.

What is claimed is:

1. A control method for opening and closing an intake valve and an exhaust valve of an engine, the engine including an intake continuous variable valve duration (CVVD) apparatus that is disposed at an intake side of the engine, an intake continuous variable valve timing (CVVT) apparatus disposed at the intake side of the engine, an exhaust CVVD apparatus that is disposed at an exhaust side of the engine, and an exhaust CVVT apparatus disposed at the exhaust side of the engine, the control method comprising:
determining, by a controller, a driving condition region among a predetermined plurality of driving condition regions that are defined by a speed of the engine and a torque of the engine; and
controlling, by the controller, an opening timing and a closing timing of each of the intake valve and the exhaust valve based on the driving condition region of the engine by controlling of operations of the intake CVVD apparatus, the intake CVVT apparatus, the exhaust CVVD apparatus, and the exhaust CVVT apparatus,
wherein controlling the opening timing and the closing timing of each of the intake valve and the exhaust valve comprises:
based on the driving condition region corresponding to a predetermined low torque region, outputting, by the controller, a control signal to provide (i) an intake valve closing (IVC) timing to be before a bottom dead center (BDC) of a stroke of the engine and (ii) an exhaust valve opening (EVO) timing to be before the BDC.

2. The control method of claim 1, further comprising:
controlling an intake valve duration for opening the intake valve to be within 180 degrees crank angle (CA) in an entirety of the driving condition region.

3. The control method of claim 2, wherein controlling the opening timing and the closing timing of each of the intake valve and the exhaust valve comprises:
based on the driving condition region corresponding to a predetermined low speed-low torque region, outputting, by the controller, a control signal to control (i) the IVC timing to be 150 to 163 degrees CA from a top dead center (TDC) of the stroke of the engine and (ii) an exhaust valve duration for opening the exhaust valve to be less than 165 degrees CA.

4. The control method of claim 3, wherein controlling the opening timing and the closing timing of each of the intake valve and the exhaust valve comprises:
outputting, by the controller, a control signal to control (i) the intake valve duration to be 161 degrees to 175 degrees CA and (ii) the exhaust valve and the intake valve to have a negative overlap.

5. The control method of claim 2, wherein controlling the opening timing and the closing timing of each of the intake valve and the exhaust valve comprises:
based on the driving condition region corresponding to a predetermined medium speed-low torque region, outputting, by the controller, a control signal to control (i) the IVC timing to be 130 degrees to 140 degrees CA from a top dead center (TDC) of the stroke of the engine and (ii) the intake valve duration to be 138 degrees to 150 degrees CA.

6. The control method of claim 5, further comprising:
outputting, by the controller, a control signal to control the exhaust valve and the intake valve to have a negative overlap.

7. The control method of claim 2, wherein controlling the opening timing and the closing timing of each of the intake valve and the exhaust valve comprises:
based on the driving condition region corresponding to a predetermined high speed-low torque region, outputting, by the controller, a control signal to control an exhaust valve duration for opening the exhaust valve to be 170 degrees to 187 degrees CA.

8. The control method of claim 7, further comprising:
outputting, by the controller, a control signal to control an overlap of the exhaust valve duration and the intake valve to be −11 degrees to 11 degrees CA.

9. The control method of claim 2, wherein controlling the opening timing and the closing timing of each of the intake valve and the exhaust valve comprises:
based on the driving condition region corresponding to a predetermined low speed-medium torque region, outputting, by the controller, a control signal to control (i) the intake valve duration to be 144 degrees to 156 degrees CA and (ii) an exhaust valve duration for opening the exhaust valve to be 165 degrees to 191 degrees CA.

10. The control method of claim 9, further comprising:
outputting, by the controller, a control signal to control an overlap of the exhaust valve and the intake valve duration to be −11 degrees to 15 degrees CA.

11. The control method of claim 2, wherein controlling the opening timing and the closing timing of each of the intake valve and the exhaust valve comprises:
based on the driving condition region corresponding to a predetermined medium speed-medium torque region, outputting, by the controller, a control signal to control (i) the intake valve duration to be 137 degrees to 149 degrees CA and (ii) an exhaust valve duration for opening the exhaust valve to be 175 degrees to 205 degrees CA.

12. The control method of claim 10, further comprising:
outputting, by the controller, a control signal to control an overlap of the exhaust valve duration and the intake valve duration to be 5 degrees to 28 degrees CA.

13. The control method of claim 2, wherein controlling the opening timing and the closing timing of each of the intake valve and the exhaust valve comprises:
based on the driving condition region corresponding to a predetermined high speed-medium torque region, outputting, by the controller, a control signal to control the EVO timing to be −200 degrees to −190 degrees CA from a top dead center (TDC) of the stroke of the engine.

14. The control method of claim 13, further comprising:
outputting, by the controller, a control signal to control the intake valve duration to be 135 degrees to 163 degrees CA.

15. The control method of claim 2, wherein controlling the opening timing and the closing timing of each of the intake valve and the exhaust valve comprises:
based on the driving condition region corresponding to a predetermined low speed-high torque region, outputting, by the controller, a control signal to control (i) the EVO timing to be −190 degrees to −154 degrees CA from a top dead center (TDC) of the stroke of the engine and (ii) an exhaust valve duration to be 155 degrees to 195 degrees CA.

16. The control method of claim 15, further comprising:
outputting, by the controller, a control signal to control an overlap of the exhaust valve duration and the intake valve to be 3 degrees to 20 degrees CA.

17. The control method of claim 15, further comprising:
outputting, by the controller, a control signal to control the intake valve duration to be 148 degrees to 177 degrees CA.

18. The control method of claim 2, wherein controlling the opening timing and the closing timing of each of the intake valve and the exhaust valve comprises:
based on the driving condition region corresponding to a predetermined medium speed-high torque region, outputting, by the controller, a control signal to control (i) the EVO timing to be −192 degrees to −166 degrees CA from a top dead center (TDC) of the stroke of the engine and (ii) an exhaust valve duration for opening the exhaust valve to increase in proportion to the speed of the engine.

19. The control method of claim 2, wherein controlling the opening timing and the closing timing of each of the intake valve and the exhaust valve comprises:
based on the driving condition region corresponding to a predetermined high speed-high torque region, outputting, by the controller, a control signal to control (i) the EVO timing to be −205 degrees to −188 degrees CA from a top dead center (TDC) of the stroke of the engine and (ii) the intake valve duration to be 140 degrees to 173 degrees CA.

20. The control method of claim 2, wherein controlling the opening timing and the closing timing of each of the intake valve and the exhaust valve comprises:
based on the driving condition region corresponding to the predetermined low torque region, outputting, by the controller, a control signal to control the EVO timing to be less than −190 degrees CA from a top dead center (TDC) of the stroke of the engine.
